(19) United States
(12) Patent Application Publication
(10) Pub. No.: US 2014/0285535 A1
(43) Pub. Date: Sep. 25, 2014

(54) ORGANIC LIGHT EMITTING DISPLAY

(71) Applicant: Samsung Display Co., Ltd., Yongin-City (KR)

(72) Inventor: Dong-Hak PYO, Yongin-City (KR)

(21) Appl. No.: 14/027,175

(22) Filed: Sep. 14, 2013

(30) Foreign Application Priority Data
Mar. 25, 2013 (KR) 10-2013-0031504

(51) Int. Cl. G09G 3/20; G09G 3/32

(52) U.S. Cl. CPC G09G 3/2018; G09G 3/3291
USPC 345/690; 345/77

(57) ABSTRACT

An organic light emitting display includes a pixel unit, a data driver, a power supply unit and a controller. The pixel unit includes a plurality of pixels, and is divided into a plurality of division areas. The data driver outputs, to the pixel unit, a data signal corresponding to image data. The power supply unit applies power voltages to the respective division areas in the pixel unit. The controller controls the power supply unit to apply each power voltage having a voltage level corresponding to the maximum gray scale level of the image data allocated to each division area, and corrects the image data so as to compensate for differences in luminance between the division areas according to different voltage levels of the power voltages.

### CLAIM PRIORITY

This application makes reference to, incorporates the same herein, and claims all benefits accruing under 35 U.S.C. §119 from an application earlier filed in the Korean Intellectual Property Office on 25 Mar. 2013 and there duly assigned Serial No. 10-2013-0031504.

### BACKGROUND OF THE INVENTION

1. Field of the Invention

An aspect of the present invention relates to an organic light emitting display.

2. Description of the Related Art

Recently, there have been developed various types of displays capable of reducing the weight and volume of cathode ray tubes, which are disadvantages. The displays include a liquid crystal display, a field emission display, a plasma display panel, an organic light emitting display, and the like.

Among these displays, the organic light emitting display displays images using organic light emitting diodes (OLEDs) that emit light through recombination of electrons and holes. The organic light emitting display has a fast response speed and is driven with low power consumption.

The above information disclosed in this Related Art section is only for enhancement of understanding of the background of the invention and therefore it may contain information that does not form the prior art that is already known to a person of ordinary skill in the art.

### SUMMARY OF THE INVENTION

Embodiments provide an organic light emitting display capable of decreasing power consumption even when a high-luminance (or high-gray-scale) data is applied to only a partial area of a pixel unit.

According to an aspect of the present invention, there is provided an organic light emitting display, including: a pixel unit including a plurality of pixels and divided into a plurality of division areas; a data driver outputting, to the pixel unit, a data signal corresponding to image data; a power supply unit applying power voltages to the respective division areas in the pixel unit; and a controller controlling the power supply unit to apply each power voltage having a voltage level corresponding to the maximum gray scale level of the image data allocated to each division area, and correcting the image data so as to compensate for differences in luminance between the division areas according to different voltage levels of the power voltages.

The controller may include a data correction unit that applies different gamma curves to the image data according to the voltage levels of the power voltages.

The data correction unit may include a luminance calculation unit calculating a variation in luminance of each division area according to a variation in voltage level of each division area with respect to a reference voltage level; a correction value computing unit computing a correction value of the image data for each division area, corresponding to the variation in luminance; and a conversion unit changing the gray scale level of the image data for each division area depending on the correction value for each division area.

The reference voltage level may be the maximum value among the voltage levels of the power voltages.

The correction value for each division area may be previously stored in the form of a plurality of gamma curves or histograms.

The controller may include a gray-scale-level detection unit detecting the maximum gray scale level of each division area from image data in one frame; a voltage level setting unit setting a voltage level in proportion to the maximum gray scale level with respect to each division area; and a power control unit controlling the power supply unit to supply the power voltage having the set voltage level for each division area.

The voltage level may be decreased as the maximum gray scale level decreases.

The voltage level of the power voltage for each division area may have a plurality of sections divided, based on a certain potential difference.

The pixel unit may be divided in a vertical or horizontal direction or may be divided in a matrix form.

The division areas may include the same number of pixels.

The power supply unit may be provided with a plurality of channels corresponding to the respective power voltages.

The power supply unit may provide the pixel unit with a high driving power voltage and a low ground power voltage, and the driving power voltage may be applied through the power channels.

The organic light emitting display may further include a scan driver supplying a scan signal and an emission control signal to the pixel unit.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic block diagram illustrating an organic light emitting display according to an embodiment of the present invention.

FIG. 2 is a view illustrating embodiments of division areas.

FIG. 3 is a block diagram illustrating the configuration of a controller shown in FIG. 1.

FIGS. 4A and 4B are views illustrating an example of power voltages applied to the respective division areas and correction values for the division areas.

### DETAILED DESCRIPTION OF THE INVENTION

The example embodiments are described more fully hereinafter with reference to the accompanying drawings. The inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like or similar reference numerals refer to like or similar elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures) of the inventive concept. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

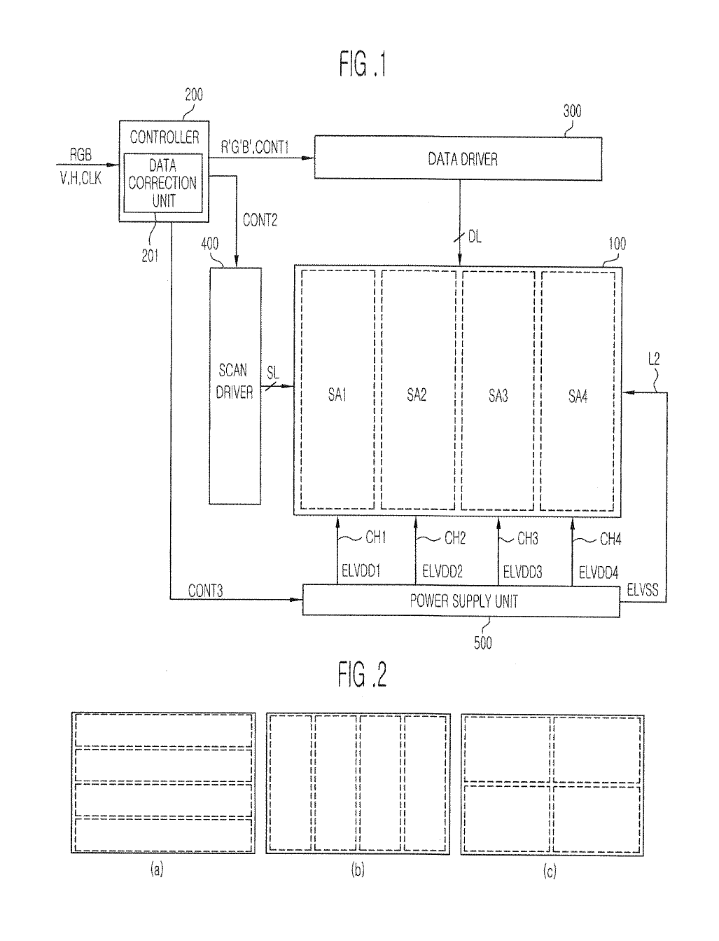

FIG. 1 is a schematic block diagram illustrating an organic light emitting display according to an embodiment of the present invention. FIG. 2 is a view illustrating embodiments of division areas.

Referring to FIG. 1, the organic light emitting display according to this embodiment includes a pixel unit 100, a controller 200, a data driver 300, a scan driver 400 and a power supply unit 500.

Although not shown in detail, the pixel unit 100 includes a plurality of pixels (not shown) arranged in a matrix form, and scan lines SL and data lines DL are coupled to the pixel unit 100. Here, the scan lines SL are formed in a first direction to provide a scan signal to the pixel unit 100 therethrough, and the data lines DL are formed in a second direction intersecting the first direction to provide a data signal to the pixel unit 100 therethrough. The pixels are formed at intersection portions of the scan lines SL and the data lines DL, and each pixel may include an organic light emitting diode and at least two transistors.

A driving power voltage ELVDD and a ground power voltage ELVSS are applied to the pixel unit 100. The driving power voltage ELVDD and the ground power voltage ELVSS are respectively coupled to anode and cathode electrodes of the organic light emitting diode provided to each pixel.

The driving power voltage ELVDD and the ground power voltage ELVSS are supplied from the power supply unit 500. The driving power voltage ELVDD has a voltage value higher than that of the ground power voltage ELVSS.

That is, in the organic light emitting display, a driving transistor included in each pixel supplies, to the organic light emitting diode, driving current with an amplitude corresponding to that of a data signal from a data line coupled to the driving transistor, and accordingly, light is generated from the organic light emitting diode, thereby displaying a predetermined image.

In this case, the driving current flows through a current path formed by a difference between the driving power voltage ELVDD and the ground power voltage ELVSS, respectively provided to the anode and cathode electrodes of the organic light emitting diode.

The pixel unit 100 may be divided into a plurality of division areas SA1 to SA4 for the purpose of power control for each area. Power channels CH1 to CH4 are coupled to the respective division areas SA1 to SA4, and a first power voltage ELVDD may be applied to the division areas SA1 to SA4 through the power channels CH1 to CH4. A second power voltage ELVSS may be applied to the pixel unit 100 through a separate power line L2 separated from the power channels CH1 to CH4.

Referring to FIG. 2, the division areas SA1 to SA4 may be divided in various forms. That is, the pixel unit 100 may be divided in various manners including horizontal division (a), vertical division (b), matrix division (c), etc.

In this case, power voltages ELVDD1 to ELVDD4 of different power levels may be applied to the respective division areas SA1 to SA4, and therefore, the number of the division areas SA1 to SA4 is necessarily identical to that of the power channels CH1 to CH4. Preferably, the division areas SA1 to SA4 have the same amplitude for the purpose of equal power control, and include the same number of pixels.

In this embodiment, four division areas SA1 to SA4 vertically divided have been described as an example. However, the shape, number and size of the division areas SA1 to SA4 may be variously modified.

The controller 200 may perform the function of a timing controller (TCON) controlling the data driver 300 and the scan driver 400.

Specifically, the controller 200 receives image data RGB of red, green and blue and input control signals for controlling display of the image data RGB, e.g., a vertical synchronization signal V, a horizontal synchronization signal H, a clock signal CLK or the like, which are input from the outside thereof.

The controller 200 controls operation timings of the data driver 300 and the scan driver 400, based on the input control signals. To this end, the controller 200 generates a data control signal CONT1 and a scan control signal CONT2, and outputs the data control signal CONT1 and the scan control signal CONT2 to the respective data and scan drivers 300 and 400.

The data control signal CONT1 may include a source start pulse (SSP), a source sampling clock (SSC), a source output enable (SOE) signal, etc. The scan control signal CONT2 may include a gate start pulse (GSP), a gate shift clock (GSC), a gate output enable (GOE) signal, etc.

The controller 200 may correct the input image data RGB and output the corrected image data R′G′B′. The controller 200 may perform the function of power control for each area by controlling the power supply unit 500.

The image data RGB contains information on luminance of each pixel, and the luminance has a predetermined number, e.g., 256 or 1024 gray scales.

Generally, the luminance of the pixel unit 100 may be increased/decreased according to the gray scale level of the image data RGB. In a case where a high-luminance (or high-gray-scale) image is displayed, a large amount of current flows in the pixel unit 100, and therefore, power consumption may be increased.

Particularly, since a high power voltage may be also applied when a high-luminance (or high-gray-scale) data may be applied to only a partial area of the pixel unit 100, power is excessively consumed.

In order to solve such a problem, in the organic light emitting display of the present invention, the power voltages ELVDD1 to ELVDD4 each having a voltage level corresponding to the maximum gray scale level for each division area may be applied to the pixel unit 100 divided into the plurality of division areas SA1 to SA4, so that power consumption can be decreased when the high-luminance (or high-gray-scale) data is applied to only a partial area of the pixel unit 100.

Differences in luminance between the division areas SA1 to SA4 may be compensated according to different voltage levels of the power voltages ELVDD1 to ELVDD4, so that it is possible to prevent a phenomenon that luminances with the same gray scale in one screen are different for each area due to the differences in luminance between the division areas SA1 to SA4.

The controller 200 calculates the maximum gray scale level from image data RGB corresponding to each of the division areas SA1 to SA4 in the pixel unit 100, and controls the power supply unit 500 to apply the power voltages ELVDD1 to ELVDD4 each having a voltage level corresponding to the calculated maximum gray scale level.

That is, the controller 200 determines the voltage level of a power voltage applied to a corresponding division area according to the gray scale level of a pixel emitting light with the maximum luminance in any one division area, and controls the power supply unit 500 by outputting a power control signal CONT3.

The controller 200 corrects image data RGB input to compensate for the differences in luminance between the division areas SA1 to SA4 according to the different voltage levels of the power voltages ELVDD1 to ELVDD4, and provides the corrected image data R′G′B′ to the data driver 300.

To this end, the controller 200 may include a data correction unit 201 that applies, to the input image data RGB, different gamma curves according to the voltage levels of the power voltages ELVDD1 to ELVDD4.

Although it has been described in this embodiment that the data correction unit 201 may be configured together with other control circuits, e.g., a timing controller, a power control circuit, etc. in the controller, the data correction unit 201 may be separated as a separate component.

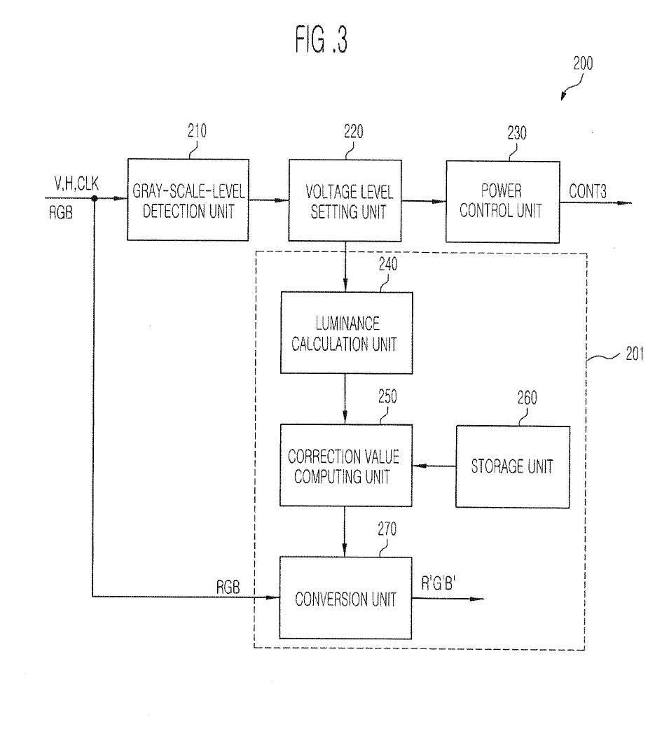

The controller 200 and the data correction unit 201 will be described in detail with reference to FIG. 3.

The data driver 300 outputs, to the pixel unit 100, image data R′G′B′ provided from the controller 200 and a data signal corresponding to the data control signal CONT1.

Specifically, the data driver 300 samples and latches image data R′G′B′ in response to the data control signal CONT1 supplied from the controller 200, and converts the image data R′G′B′ into data of a parallel data structure. When the image data R′G′B′ is converted into the data of the parallel data structure, the data driver 300 converts digital image data R′G′B′ into an analog data signal (data voltage) through conversion of the digital image data R′G′B′ into a gamma reference voltage. The data driver 300 applies the generated data signal to the pixel unit 100 coupled through the data lines DL.

Here, the data driver 300 may extracts a plurality of gamma points from a predetermined gamma curve (generally, a gamma 2.2 curve) so as to generate the data signal from a gamma generation circuit (not shown), and receive a gamma reference voltage provided according to the plurality of gamma points.

The scan driver 400 outputs, to the pixel unit 100, a scan signal corresponding to the scan control signal CONT2.

Specifically, the scan driver 400 sequentially generates a scan signal by shifting the level of the scan signal with the swing width of a gate driving voltage at which transistors of the pixels included in the pixel unit 100, in response to the scan control signal CONT2 supplied from the controller 200. The scan driver 400 supplies the generated scan signal to the pixel unit 100 coupled thereto through the scan lines SL.

The scan driver 400 may include a scan driving circuit generating scan signals and an emission driving circuit generating emission control signals. The scan driving circuit and the emission driving circuit may be included as one component or may be separated as separate components.

The power supply unit 500 applies the power voltages ELVDD1 to ELVDD4 to the pixel unit 100 according to the power control signal CONT3. To this end, the power supply unit 500 may be provided with a plurality of power channels CH1 to CH4 corresponding to the respective power voltages ELVDD1 to ELVDD4.

As described above, the driving power voltage ELVDD may be applied through the power channels CH1 to CH4, and the ground power voltage ELVSS may be applied through the separate power line L2 separated from the power channels CH1 to CH4.

In another embodiment, the driving power voltage ELVDD and the ground power voltage ELVSS may be applied to the pixel 100 through the power channels CH1 to CH4 and the power line L2, which form a pair.

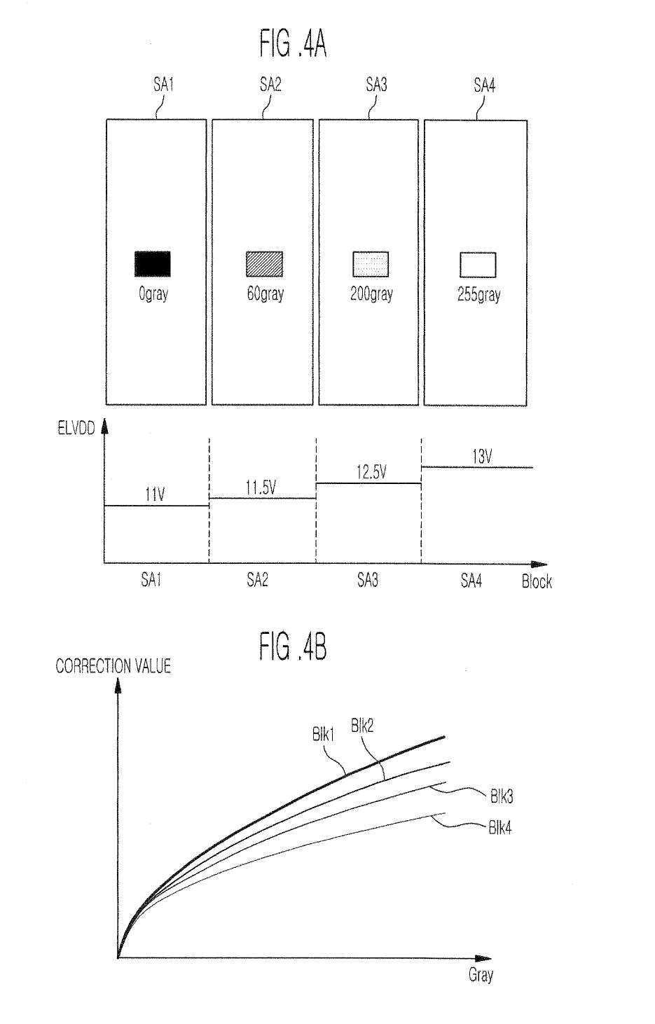

FIG. 3 is a block diagram illustrating the configuration of the controller shown in FIG. 1. FIGS. 4A and 4B are views illustrating an example of power voltages applied to the respective division areas and correction values for the division areas.

Referring to FIG. 3, the controller 200 according to this embodiment may include a gray-scale-level detection unit 210, a voltage-level setting unit 220, a power control unit 230, a luminance calculation unit 240, a correction-value computing unit 250, a storage unit 260 and a conversion unit 270.

The gray-scale-level detection unit 210 detects the maximum gray scale level of each of the division areas SA1 to SA4 from image data RGB in one frame.

Specifically, the gray-scale-level detection unit 210 receives image data RGB and input control signals, input from the outside thereof. The gray-scale-level detection unit 210 may decide to which division area the image data RGB are allocated, based on the vertical synchronization signal V and the horizontal synchronization signal H, input together with the image data RGB.

The gray-scale-level detection unit 210 decides to which division area the sequentially input image data RGB are allocated, and determines the maximum value among gray scale levels of the image data RGB belonging to each of the division areas SA1 to SA4. The process of detecting the maximum gray scale level for each division area in the gray-scale-level detection unit 210 may be performed for each frame.

The voltage level setting unit 220 sets a voltage level in proportion to the maximum gray scale level with respect to each of the division areas SA1 to SA4.

Specifically, the voltage level setting unit 220 decreases the voltage level of each power voltage applied to a corresponding division area as the maximum gray scale level decreases, and increases the voltage level as the maximum gray scale level increases. Here, the voltage level of each of the power voltages ELVDD1 to ELVDD4 may be determined in such a manner that a plurality of sections are divided, based on a certain potential difference.

The power control unit 230 controls the power supply unit 500 to supply each of the power voltages ELVDD1 to ELVDD4, which has the voltage level set in the voltage level setting unit 220.

That is, the voltage level of the power voltage applied to any one division area determined according to the gray scale level of the portion at which light may be emitted with the maximum luminance in the corresponding division area. The power control unit 230 controls the power supply unit 500 by outputting the power control signal CONT3 having information on the voltage level of the determined power voltage.

Referring to FIG. 4A, it is assumed that the gray-scale-level detection unit 210 detects gray scale 0 as the maximum gray scale level of the first division area SA1, gray scale 60 as the maximum gray scale level of the second division area SA2, gray scale 200 as the maximum gray scale level of the third division area SA3, and gray scale 255 as the maximum gray scale level of the fourth division area SA4. Here, examples of the division areas SA1 to SA4 may be variously modified as described above. Instead of 256 gray scales (0 to 255), 1024 gray scales may be applied as the range of gray scale levels.

After the maximum gray scale level for each division area is detected, the voltage level setting unit 220 sets the voltage levels of the first to fourth division area SA1 to SA4 respectively to 11V, 11.5V, 12.5V and 13V. That is, the voltage level of the division area having a low maximum gray scale level may be set low, and the voltage level of the division area having a high maximum gray scale level may be set high. Here, the voltage level is determined in a range of minimum 11V to maximum 13V by the unit of 0.5V, but the present invention is not limited thereto. That is, the voltage level may be determined in various manners.

Next, if the power control unit 230 outputs the power control signal CONT3, the power supply unit 500 applies the power voltages ELVDD1 to ELVDD4 to the respective division areas SA1 to SA4 of the pixel unit 100. Specifically, the first power voltage ELVDD1 of 11V may be applied to the first division area SA1 through the first power channel CH1, and the second power voltage ELVDD2 of 11.5V may be applied to the second division area SA2 through the second power channel CH2. The third power voltage ELVDD3 of 12.5V may be applied to the third division area SA3 through the third power channel CH3, and the fourth power voltage ELVDD4 of 13V may be applied to the fourth division area SA4 through the fourth power channel CH4.

The luminance calculation unit 240 calculates a variation in the luminance of each of the division areas SA1 to SA4 according to a change in the voltage level of the division area with respect to a reference voltage level. Here, the reference voltage level may be the maximum value among the voltage levels of the power voltages.

That is, the luminance calculation unit 240 calculates a difference in luminance according to the difference in voltage level with respect to the division area to which a voltage level lower than the reference voltage level, based on a voltage level corresponding to the maximum gray scale level in one frame. The luminance of light emitted from the organic light emitting diode in each pixel may be changed depending on the amplitude of driving current, and the driving current may be determined according to the voltage level of the applied data signal (data voltage) and the voltage level of the driving power voltage ELVDD. Since the amplitude of the data signal corresponds to the gray scale level, a luminance value and a variation in luminance according to the change in voltage level may be calculated, based on the voltage level of image data RGB and the voltage level of each of the power voltages ELVDD1 to ELVDD4.

The correction value computing unit 250 computes a correction value for each area of the image data RGB, corresponding to the variation in luminance. That is, in order to prevent degradation of luminance due to a decrease in the voltage level of the driving power voltage ELVDD, the correction value computing unit 250 determines an increment of the gray scale level of the image data RGB as the luminance is decreased. The correction value for each division area may be previously stored in the form of a plurality of gamma curves or histograms in the storage unit 260.

The storage unit 260 may be configured with at least one look-up table, EEPROM, etc. The stored correction value may be a value previously measured and calculated so that characteristics of a product are appropriately optimized.

The conversion unit 270 changes the gray scale level of image data RGB for each division area according to the correction value for each division area. That is, the conversion unit 270 scales the gray scale level of the image data RGB according to the correction value for each division area, thereby outputting the corrected image data R′G′B′.

Referring to FIG. 4B, the conversion unit 270 may apply different gamma curves to image data RGB according to the voltage level of each of the power voltages ELVDD1 to ELVDD4. Specifically, a first correction value Blk1 may be applied to image data RGB corresponding to the first division area SA1 to which the first power voltage ELVDD1 of 11V may be applied, and a second correction value Blk2 may be applied to image data RGB corresponding to the second division area SA2 to which the second power voltage ELVDD2 of 11.5V may be applied. A third correction value Blk3 may be applied to image data RGB corresponding to the third division area SA3 to which the third power voltage ELVDD3 of 12.5 may be applied, and a fourth correction value Blk4 may be applied to image data RGB corresponding to the fourth division area SA4 to which the fourth power voltage ELVDD4 of 13V may be applied.

By way of summation and review, the organic light emitting display includes a plurality of data lines, a plurality of scan lines, and a pixel unit including a plurality of pixels formed at intersection portions of the data lines and the scan lines. Each pixel includes an OLED and a driving transistor coupled to the OLED. A driving power voltage ELVDD and a ground power voltage ELVSS are supplied to the pixel unit so as to apply a predetermined voltage to anode and cathode electrodes of the OLED provided in each pixel.

That is, in the organic light emitting display, the driving transistor included in each pixel supplies, to the OLED, driving current with an amplitude corresponding to that of a data signal supplied from the data line coupled to the driving transistor, and accordingly, light is emitted from the OLED, thereby displaying a predetermined image.

In this case, the driving current flows through a current path formed by a difference between the driving power voltage ELVDD and the ground power voltage ELVSS, respectively provided to the anode and cathode electrodes of the OLED.

In a case where the organic light emitting display displays a high-luminance (or high-gray scale) image, a large amount of current flows through the OLED of each pixel included in the pixel unit. In a case where the organic light emitting display displays low-luminance (or low-gray-scale) image, a small amount of current flows through the OLED of each pixel.

However, in a case where the high-luminance (or high-gray-scale) image is displayed, a large load may be applied to a power supply means providing the driving power voltage ELVDD and the ground power voltage ELVSS due to the large amount of current flowing in the pixel unit, and therefore, power consumption is increased.

Conventionally, to solve such a problem, there was a method of detecting the maximum gray scale level in one frame and determining the voltage level of a power voltage, corresponding to the maximum gray scale level. That is, if the maximum gray scale level is high, the voltage level of the power voltage is increased. If the maximum gray scale level is low, the voltage level of the power voltage is decreased.

However, according to the conventional method, in a case where a high-luminance (or high-gray-scale) data may be applied to only a partial area of the pixel unit, a high power voltage may be also applied to the entire area of the pixel unit. Hence, it is difficult to expect a reduction in power consumption, caused by a voltage drop of the power voltage.

As described above, according to an embodiment of the present invention, power voltages each having a voltage level corresponding to the maximum gray scale level for each division area are applied to the pixel unit divided into a plurality of division areas, so that it is possible to reduce power consumption even when a high-luminance (or high-gray-scale) data is applied to only a partial area of the pixel unit.

Further, differences in luminance between the division areas are compensated according to different voltage levels of the power voltages, so that it is possible to prevent a variation in luminance between the division areas.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An organic light emitting display, comprising:
a pixel unit including a plurality of pixels and divided into a plurality of division areas;
a data driver outputting a data signal corresponding to image data to the pixel unit;
a power supply unit applying power voltages to the respective division areas in the pixel unit; and
a controller controlling the power supply unit to apply each power voltage having a voltage level corresponding to the maximum gray scale level of the image data allocated to each division area, and correcting the image data so as to compensate for differences in luminance between the division areas according to different voltage levels of the power voltages.

2. The organic light emitting display of claim 1, wherein the controller includes a data correction unit that applies different gamma curves to the image data according to the voltage levels of the power voltages.

3. The organic light emitting display of claim 2, wherein the data correction unit includes:
a luminance calculation unit calculating a variation in luminance of each division area according to a variation in voltage level of each division area with respect to a reference voltage level;
a correction value computing unit computing a correction value of the image data for each division area, corresponding to the variation in luminance; and
a conversion unit changing the gray scale level of the image data for each division area depending on the correction value for each division area.

4. The organic light emitting display of claim 3, wherein the reference voltage level is the maximum value among the voltage levels of the power voltages.

5. The organic light emitting display of claim 3, wherein the correction value for each division area is previously stored in the form of a plurality of gamma curves or histograms.

6. The organic light emitting display of claim 1, wherein the controller includes:
a gray-scale-level detection unit detecting the maximum gray scale level of each division area from image data in one frame;
a voltage level setting unit setting a voltage level in proportion to the maximum gray scale level with respect to each division area; and
a power control unit controlling the power supply unit to supply the power voltage having the set voltage level for each division area.

7. The organic light emitting display of claim 6, wherein the voltage level is decreased as the maximum gray scale level decreases.

8. The organic light emitting display of claim 1, wherein the voltage level of the power voltage for each division area has a plurality of sections divided, based on a certain potential difference.

9. The organic light emitting display of claim 1, wherein the pixel unit is divided in a vertical or horizontal direction or is divided in a matrix form.

10. The organic light emitting display of claim 1, wherein the division areas include the same number of pixels.

11. The organic light emitting display of claim 1, wherein the power supply unit is provided with a plurality of channels corresponding to the respective power voltages.

12. The organic light emitting display of claim 11, wherein the power supply unit provides the pixel unit with a high driving power voltage and a low ground power voltage, and the driving power voltage is applied through the power channels.

13. The organic light emitting display of claim 1, further comprising a scan driver supplying a scan signal and an emission control signal to the pixel unit.

14. An organic light emitting display, comprising:
a pixel unit divided into a plurality of division areas with each division area of the plurality of pixel areas having a plurality of pixels;
a data driver outputting a data signal corresponding to image data to the pixel unit;
a power supply unit applying independently adjustable power voltages to each of the plurality of division areas in the pixel unit; and
a controller controlling the power supply unit to apply the power voltage having different voltage levels that correspond to a maximum gray scale level of the image data allocated to each division area of the plurality of pixel areas, and correcting the image data compensating for differences in luminance between the division areas according to different voltage levels of the power voltages.

15. The organic light emitting display of claim 14, wherein the controller includes a data correction unit that applies different gamma curves to the image data according to the voltage levels of the power voltages.

16. The organic light emitting display of claim 15, wherein the data correction unit includes:
a luminance calculation unit calculating a variation in luminance of each division area according to a variation in voltage level of each division area with respect to a reference voltage level;
a correction value computing unit computing a correction value of the image data for each division area, corresponding to the variation in luminance; and
a conversion unit changing the gray scale level of the image data for each division area depending on the correction value for each division area.

17. The organic light emitting display of claim 16, wherein the reference voltage level is the maximum value among the voltage levels of the power voltages.

18. The organic light emitting display of claim 16, wherein the correction value for each division area is previously stored in the form of a plurality of gamma curves or histograms.

19. The organic light emitting display of claim 14, wherein the controller includes:
a gray-scale-level detection unit detecting the maximum gray scale level of each division area from image data in one frame;
a voltage level setting unit setting a voltage level in proportion to the maximum gray scale level with respect to each division area; and
a power control unit controlling the power supply unit to supply the power voltage having the set voltage level for each division area.

20. The organic light emitting display of claim 19, wherein the voltage level is decreased as the maximum gray scale level decreases.
